(19) United States
(12) Patent Application Publication
(10) Pub. No.: US 2011/0187776 A1
(43) Pub. Date: Aug. 4, 2011

(54) Multiple Inkjet Cannon Printing System

(75) Inventor: Scott Seipel, Southlake, TX (US)

(73) Assignee: POLY-AMERICA, L.P., Grand Prairie, TX (US)

(21) Appl. No.: 12/697,379

(22) Filed: Feb. 1, 2010

(51) Int. Cl. B41J 29/38

(52) U.S. Cl. 347/14

(57) ABSTRACT

The present invention is directed toward a system for printing on a moving substrate. The present invention comprises at least a first inkjet cannon and a second inkjet cannon, both the first inkjet cannon and second inkjet cannon positioned for printing on a moving substrate. The first inkjet cannon and the second inkjet cannon are controlled to allow for simultaneous printing of two messages on the moving substrate. The simultaneous printing may be controlled by two or more subcontrollers. A speed sensor or a trigger sensor may be attached for more precisely controlling the printing on the moving substrate.

### CROSS-REFERENCE TO RELATED APPLICATIONS

Not applicable.

### BACKGROUND AND SUMMARY OF THE INVENTION

1. Field of the Invention

The present invention generally relates to a new system for inkjet printing in industrial and manufacturing applications. In particular, the present invention relates to improvements in inkjet printing by providing multiple stationary synchronized inkjet cannons to produce large multiple line messages on plastic film products.

2. Description of the Related Art and the Present Invention

Inkjet printing technology has been used for many years in a variety of applications. Inkjet technology works by creating small drops of ink which are precisely placed onto a printing substrate to form a pattern, picture, or text. The most common and well known application is the incorporation of inkjet technology into computer printers found in homes and offices worldwide. However, inkjet technology is also used in the industrial and manufacturing areas where the technology is used to put various codes and markers on products and packaging. One common example is the use of inkjet technology to print a “sell-by” or “use-by” date on food product packaging.

Applications of inkjet printing in the manufacturing context usually involve single-color printing on product packaging. The printing is typically provided by a single, stationary inkjet cannon, or inkjet printhead, to print text, barcodes, images, or some combination of the foregoing onto a product surface. One of the primary advantages of inkjet technology is that printing can be done on almost any surface. Because the ink drops are propelled from the printhead onto the surface rather than through physical contact with the printing surface such as in offset printing, inkjet printing can be used on a variety of irregular or curved surfaces.

Although inkjet printing does not require physical contact between the printing head and the printing surface, the design of typical industrial inkjet printers inherently limits the size of the text. More specifically, since the inkjet printing head, or inkjet cannon, is maintained in a stationary position, the printing is necessarily limited to a small range. For high-speed printing such as that used in the manufacturing context, the maximum height of text and/or graphics that can be printed by a single inkjet cannon is approximately ⅓ of an inch. The present invention allows for the printing of large character, multiple-line messages on high-speed manufacturing lines.

### SUMMARY OF THE INVENTION

The present invention provides an inkjet printing system for printing on a moving substrate. In one embodiment of the present invention, the system comprises a moving substrate traveling in a first direction. A first inkjet cannon and a second inkjet cannon are provided which are oriented in a perpendicular manner to the moving substrate to allow for printing on the moving substrate simultaneously in two different areas of the moving substrate.

In some embodiments of the present invention, the system may further comprise a controller for controlling the first inkjet cannon and the second inkjet cannon. Additionally, the controller device may be comprised of a first subcontroller for controlling the first inkjet cannon and a second subcontroller for controlling the second inkjet cannon.

In certain embodiments of the present invention, the first inkjet cannon and the second inkjet cannon remain stationary with respect to the moving substrate. Additionally, certain embodiments may include a speed sensor coupled to the controller device for detecting the speed of the moving substrate. Certain embodiments may further include a trigger sensor coupled to the controller device, the trigger sensor indicating to the controller device when a new message shall be printed onto the moving substrate. In additional embodiments of the present invention, the inkjet printing system is utilized in a system where the moving substrate is a film of thin plastic, or a web of plastic film.

Another aspect of the present invention is a new method for printing on a moving substrate. The new method provides a moving substrate for printing and then simultaneously printing on the moving substrate with a first inkjet cannon while also printing on the moving substrate with a second inkjet cannon. A controller may be utilized to control the first inkjet cannon and the second inkjet cannon. The controller may utilize a plurality of subcontrollers, each subcontroller responsible for controlling a single inkjet cannon, with the subcontrollers electronically coupled to one another to allow for synchronized operation of the subcontrollers and the plurality of inkjet cannons.

### BRIEF DESCRIPTION OF THE RELATED DRAWINGS

A full and complete understanding of the present invention may be obtained by reference to the detailed description of the present invention and preferred embodiment when viewed with reference to the accompanying drawing.

FIG. 1 provides a perspective view of an inkjet cannon/printhead as known in the prior art.

FIG. 2 provides a diagram view of one embodiment of the present invention and the components comprising the system.

FIG. 3 provides a perspective view of the inkjet cannons and the material substrate as contemplated by one embodiment of the present invention.

### DETAILED DESCRIPTION OF THE INVENTION

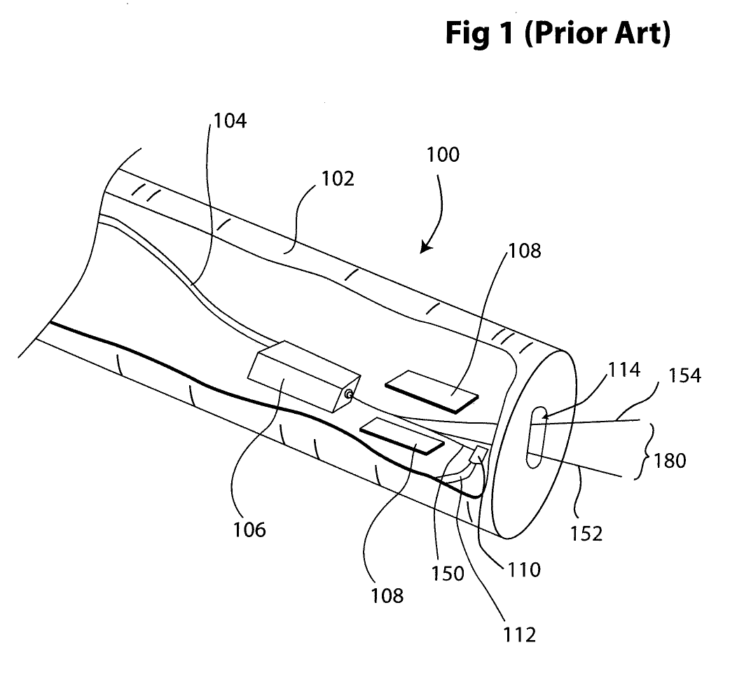

FIG. 1 depicts a typical inkjet cannon 100, or inkjet printhead, used in an industrial or manufacturing application. The typical inkjet cannon 100 used in such applications is typically a continuous ink jet, meaning that a stream of ink droplets are constantly produced with unused ink recycled back into the ink supply system. In typical inkjet cannons, an outer case 102 is provided which contains the majority of the operating components including the components which produce the drops of ink for printing.

The internal components include a pressurized ink line 104 which is fed into the gunbody 106. The gunbody 106 contains several components including a microscopic nozzle and acoustic wave generator which break the constant supply of ink into a series of very small droplets. The gunbody 106 also contains a charging electrode coupled to the printing controller which creates a controlled, variable electrostatic charge on each ink droplet as the respective droplet is formed. After the ink droplets are formed and charged as desired, the droplets travel out of the gun body 106 and through a constant electrostatic field generated by opposing electrostatic deflection plates 108.

In a continuous ink jet system, as commonly used in a manufacturing environment, the gunbody 106 produces a constant stream of ink droplets. As noted above, an electrostatic charge is applied in the gunbody 106 to the drops by a printing controller. When the inkjet cannon 100 does not need to print any text or graphics, the ink droplets are not imparted with any electrostatic charge, but remain electrostatically neutral. The uncharged ink droplets travel out of the gunbody 106, following a straight path 150 through the electrostatic charge created by the opposing electrostatic deflection plates 108. The uncharged ink droplet is then collected by an ink recycler 110 and the ink travels through an ink return line 112 back to an ink well and eventually back through the pressurized ink line 104. On the other hand, applying a precise charge to an ink droplet allows the inkjet cannon 100 to alter the path of the ink droplet so that it will land on a printing surface.

If an ink droplet is imparted with a charge, the resulting ink droplet will be deflected as it travels through the constant electrostatic field created by the opposing electrostatic deflection plates 108. The greater the charge on the ink droplet, the greater the deflection of the ink droplet as the ink droplet travels between the opposing electrostatic deflection plates 108. For example, ink droplets with a small charge will be slightly deflected following a slightly curved path 152. The ink droplet avoids the ink recycler 110 and travels out of the inkjet cannon 100 through an opening 114 in the outer shell 102. On the other hand, ink droplets with a greater charge will be significantly deflected, following a more curved path through the electrostatic plates 108 as shown by path 154. The highly charged particles will thus land toward the top of a printing field 180 while the minimally charged particles will land at the bottom of the printing field 180. Precisely controlling the charge imparted on the ink droplet allows the ink droplet to be placed at any location within the printing field 180.

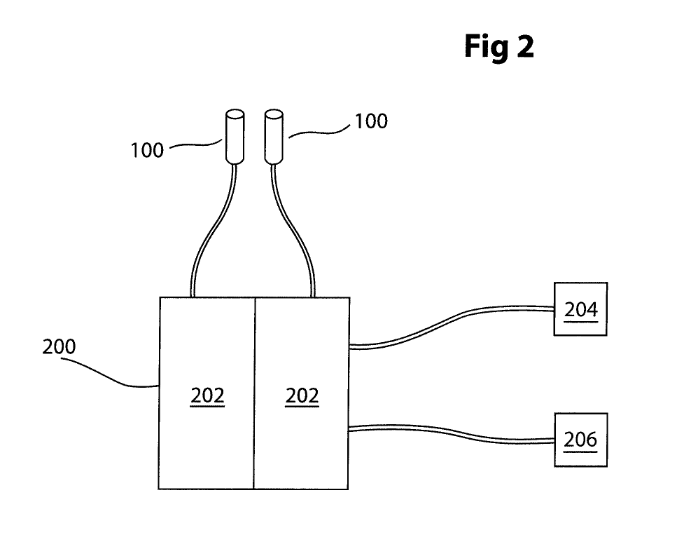

In commercial applications, the ink droplets will be either uncharged, or neutral, or given one of multiple distinct charge levels. For example, with respect to an inkjet cannon capable of printing a matrix formed from 12 distinct dots in the vertical printing direction, the inkjet cannon and controller must be capable of providing one of 12 distinct charges on a particular ink droplet, in addition to the neutral charge for non-printed ink droplets. Most commercial applications are capable of producing between 12 and 24 different, distinct charges, which translates into 12 to 24 dot-lines of printing. The charge levels are controlled by the inkjet controller as depicted in FIG. 2.

In addition to the limits on the number of dot-lines, an inkjet cannon 100 is limited in its operating range from the material substrate. Decreasing or increasing the distance of an inkjet cannon from the material substrate allows the absolute size of the printing field 180 to be decreased to near-zero or increased infinitely. However, as a practical matter, the inkjet cannons 100 are designed to operate in a certain distance range from the material substrate. If the inkjet cannon 100 is too close to the material substrate, the ink droplets will be too large, overlapping one another, and possibly splattering, resulting in garbled printed messages or graphics. On the other hand, if the inkjet cannon 100 is moved too far from the material substrate, the path of the ink droplets are less predictable due to external forces such as gravity, wind currents, and external electrical fields acting on the ink droplets. Furthermore, as the distance is increased, the separation between contiguous dots will also increase, again resulting in messages or graphics that are difficult to read. Under typical manufacturing conditions seen in the prior art, the maximum size for a printing field 180 on a fast moving printing substrate is typically no greater than one-third of an inch.

FIG. 2 provides an abstract view of the components of one embodiment of the present invention. As shown in FIG. 2, two or more inkjet cannons 100 are coupled to an inkjet controller 200. In the depicted embodiment, the inkjet controller 200 consists of two subcontrollers 202. Each subcontroller 202 is responsible for controlling the operation of a corresponding inkjet cannon 100. Some embodiments of the present invention may further include a speed sensor 204 used to accurately detect the speed of the moving substrate. The speed sensor 204 may be coupled to one or more subcontrollers. Alternatively, the subcontrollers may be interlinked to communicate information about the speed of the moving material substrate. The subcontrollers 202 adjust the operating frequency of the inkjet cannons 100 depending upon the measured speed of the moving material substrate to provide consistent results within a range of different operating speeds.

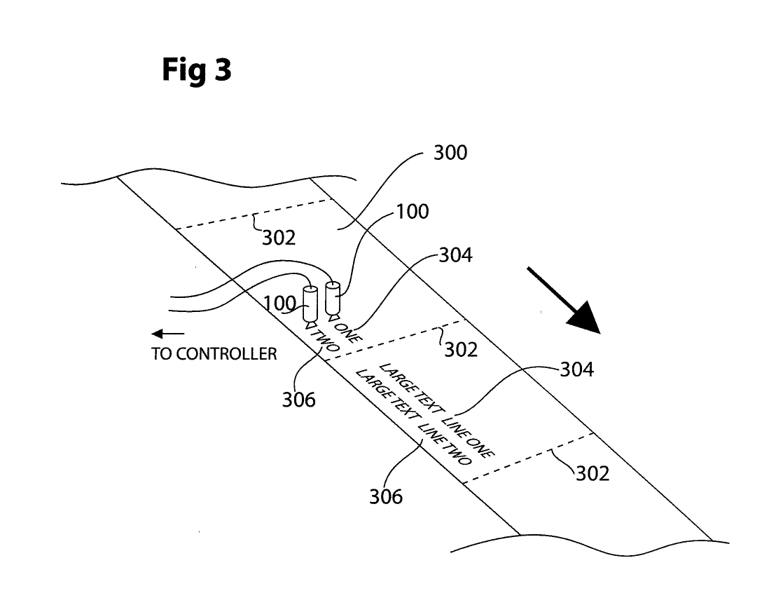

Furthermore, in some embodiments it may be desirable to further include a trigger sensor 206. The trigger sensor 206 can be used to detect the boundary between two objects for printing purposes. For example, in certain embodiments of the present invention, the trigger sensor 206 may be used to detect the boundary between plastic bags within a thermoplastic web. When the trigger sensor 206 indicates such a boundary, it may indicate to the controller 200 or subcontrollers 202 that certain messages should be simultaneously printed by two or more inkjet cannons 100 onto a single bag. For example, one inkjet cannon 100 may print the first half of a warning message on a trash bag while a second inkjet cannon 100 prints the second half of the message. This is better illustrated with respect to FIG. 3.

FIG. 3 provides a perspective view of one embodiment of the present invention. In the depicted embodiment, two inkjet cannons 100 are shown. Each inkjet cannon 100 is positioned perpendicular to the moving substrate 300, in this case a thermoplastic web moving in the direction shown by the arrow. The thermoplastic web is perforated along lines 302 to divide successive trash bags. For simplicity in the illustration, the controller 200 and other components described with respect to FIG. 2 are omitted. The two inkjet cannons 100 are positioned roughly parallel to one another along the width of the material substrate 100.

As shown in embodiment of FIG. 3, the first inkjet cannon 100 prints a first message 304 on the material substrate 300 while the second inkjet cannon 100 prints a second message 306. The first message line 304 and second message line 306 are printed at the same time. This configuration allows for significantly larger font sizes for a message of a given length than would otherwise be permitted by a single inkjet cannon 100 arrangement as known in the prior art. In the prior art, a single cannon could be used to produce two lines of text, but the height of each line would be limited to one-half of the maximum height, or roughly one-sixth of an inch. The larger font sizes are most critical for making messages or warnings conspicuous. Therefore, when a need arose to print a long message in font sizes at least one-third inch in height, a single inkjet cannon to print the message proved infeasible because the resulting length of the printed message exceeded the length of the respective product. Therefore, it became necessary to develop the present invention, using one inkjet cannon 100 to print the first half of the message with a second inkjet cannon 100 printing the second half of the message directly below it.

The embodiments depicted herein are not intended to limit the scope of the present invention. Indeed, it is contemplated that any number of different embodiments may be utilized without diverging from the spirit of the invention. Therefore, the appended claims are intended to more fully encompass the scope of the present invention.

I claim:

1. An inkjet printing system for printing on a moving substrate, comprising:
a moving substrate traveling in a first direction,
a first inkjet cannon, the first inkjet cannon oriented substantially perpendicular to the moving substrate,
a second inkjet cannon, the second inkjet cannon oriented substantially perpendicular to the moving substrate,
the first inkjet cannon and the second inkjet cannon positioned to allow for simultaneous printing in two different areas of the moving substrate.

2. The inkjet printing system of claim 1, further comprising:
a controller device coupled to the first inkjet cannon and the second inkjet cannon.

3. The inkjet printing system of claim 2,
the controller device further comprising:
a first subcontroller coupled to the first inkjet cannon for controlling the first inkjet cannon, and
a second subcontroller coupled to the second inkjet cannon for controlling the second inkjet cannon.

4. The inkjet printing system of claim 1,
the first inkjet cannon further comprising:
a first continuous inkjet print head.

5. The inkjet printing system of claim 4,
the second inkjet cannon further comprising:
a second continuous inkjet print head.

6. The inkjet printing system of claim 1, further comprising:
the first inkjet cannon being generally stationary, and
the second inkjet cannon being generally stationary.

7. The inkjet printing system of claim 2, further comprising:
a speed sensor coupled to the controller device, wherein the speed sensor detects a speed of the moving substrate.

8. The inkjet printing system of claim 2, further comprising:
a trigger sensor coupled to the controller device, wherein the trigger sensor indicates to the controller device when a new message shall be printed onto the moving substrate.

9. The inkjet printing system of claim 1, further comprising:
the moveable substrate comprises a web of thin plastic film.

10. A method for printing on a moving substrate comprising the steps of:
providing a moving substrate, and
printing on the moving substrate with a first inkjet cannon and simultaneously printing on the moving substrate with a second inkjet cannon.

11. The method of claim 10, further comprising the step of:
controlling the first inkjet cannon and the second inkjet cannon with a controller.

12. The method of claim 11, further comprising the steps of:
controlling the first inkjet cannon with a first subcontroller, and
controlling the second inkjet cannon with a second subcontroller.
